(19) United States
(12) Patent Application Publication
(10) Pub. No.: US 2025/0043154 A1
(43) Pub. Date: Feb. 6, 2025

(54) METHOD FOR PREPARING FLEXIBLE MAGNETIC STRIP CARRIER, FLEXIBLE MAGNETIC STRIP CARRIER AND EYELASH DECORATION

(71) Applicant: Shenzhen Mlen Biotechnology Co., LTD, Shenzhen (CN)

(72) Inventor: Linyan WU, Shenzhen (CN)

(73) Assignee: Shenzhen Mlen Biotechnology Co., LTD, Shenzhen (CN)

(21) Appl. No.: 18/920,756

(22) Filed: Oct. 18, 2024

Related U.S. Application Data
(63) Continuation of application No. PCT/CN2023/083203, filed on Mar. 22, 2023.

(30) Foreign Application Priority Data
Apr. 29, 2022 (CN) 2022104680348

(51) Int. Cl. C09J 7/28; A41G 5/02; H01F 1/057

(52) U.S. Cl. CPC C09J 7/28; A41G 5/02; H01F 1/057

(57) ABSTRACT

The invention relates to the technical field of decorative decorations, in particular, to a method for preparing a flexible magnetic strip carrier, a flexible magnetic strip carrier and an eyelash decoration. The method for preparing a flexible magnetic strip carrier includes the following steps: S1, a carrier sheet and a flexible magnetic sheet are provided; S2, the flexible magnetic sheet is cut to obtain a cut flexible magnetic sheet; S3, a side of the cut flexible magnetic sheet away from the base layer is magnetized. In the invention, overall cutting is easy to carry out, and the small magnetic sheets will not slide during magnetization.

### CROSS-REFERENCE TO RELATED APPLICATIONS

The application claims priority to Chinese patent application No. 2022104680348, filed on Apr. 29, 2022, the entire contents of which are incorporated herein by reference.

### TECHNICAL FIELD

The invention relates to the technical field of decorative decorations, in particular, to a method for preparing a flexible magnetic strip carrier, a flexible magnetic strip carrier and an eyelash decoration.

### BACKGROUND

With the development of the market economy, more and more people pay attention to makeup and modification, especially women.

In order to make their body and appearance more beautiful, in addition to traditional makeup and modification, they also pay more attention to details. Under this demand, the eyelash market is developing rapidly. Current magnetic eyelash decorations use flexible magnetic strips as carriers based on traditional hard magnets. They are easy to bend during wearing and are more comfortable to wear. They also use a multi-pole magnetization method to form magnetic units arranged in an “NSNS . . . ” sequence, making them more convenient to wear. The improvements in the above products have also promoted a significant increase in the market demand for such products.

The processing of the flexible magnetic strip carrier used in this type of eyelash decorations mainly includes the following steps:

1) the magnetic powder, the binder and the additive are formed by a calendering process to obtain a magnetic sheet coil; 2) the magnetic sheet is cut into small magnetic sheets with a length of about 10 mm, a width of about 1 mm, and a thickness of about 0.1 mm using a die-cutting machine; 3) the small magnetic sheets are placed in the groove of a magnetizing mold, and a magnetizing machine is used to perform multi-pole magnetization on one side, wherein the side of the small magnetic sheet away from the groove of the mold is the strong magnetic side; 4) the eyelash decoration body is bonded to the edge of the weak magnetic surface of the small magnetic sheet with medical-grade strong glue to form a complete eyelash decoration.

During the processing, the carrier magnetic strip needs to be placed on the magnetizing mold, so that due to the small size and light weight of the carrier magnetic strip, the operation is inconvenient, and the small magnetic sheet is easy to shift during magnetization; when the eyelash decoration is bonded to the magnetic strip carrier, it is difficult to distinguish the strong magnetic side and the weak magnetic side of the small magnetic sheet. The above processing method has low efficiency in production and poor consistency in product quality, making it difficult to meet the market requirements for quality and quantity.

The information disclosed in this background section is only intended to enhance understanding of the overall background of the invention and should not be taken as an acknowledgement or any form of suggestion that the information constitutes the prior art already known to a person skilled in the art.

### SUMMARY

Aiming at the problem that the processing of flexible magnetic strip carriers in the prior art is inconvenient to operate, which affects product quality and production efficiency, an objective of the invention is to provide a method for preparing a flexible magnetic strip carrier. In the method, by loading the magnetic sheets on the adhesive layer, after the magnetic sheets are cut, the small magnetic sheets are bonded to the adhesive layer, and the whole magnetic sheets may be magnetized, so that the product consistency is good, and the efficiency in production is improved.

In order to achieve above objective, the invention employs the following technical solutions:

A method for preparing a flexible magnetic strip carrier includes steps of:
S1, providing a carrier sheet and a flexible magnetic sheet, wherein the carrier sheet includes a base layer and an adhesive layer which are stacked and the flexible magnetic sheet is bonded to the adhesive layer;
S2, cutting the flexible magnetic sheet to obtain a cut flexible magnetic sheet, wherein the cut flexible magnetic sheet includes a plurality of small magnetic sheets, and the small magnetic sheets are all bonded to the adhesive layer;
in the process of cutting, a cutter cuts from a side of the flexible magnetic sheet away from the carrier sheet, penetrates the flexible magnetic sheet, and does not exceed a surface of the base layer away from the adhesive layer;
S3, magnetizing a side of the cut flexible magnetic sheet away from the base layer, wherein the small magnetic sheet after magnetization is the flexible magnetic strip carrier.

By bonding the flexible magnetic sheet to the carrier sheet to form a whole sheet structure and by only cutting the flexible magnetic sheet layer during cutting,

it is easy to use a die-cutting tool to cut the whole sheet, and the small magnetic strips formed after cutting are bonded to the carrier sheet and will not fall off; during magnetization, the entire flexible magnetic sheet after cutting may be magnetized as a whole, and may adapt to a flat magnetizing mold; during magnetization, the small magnetic sheet will not slide, and the consistency of the magnetization effect of the small magnetic sheet may be guaranteed. The method is further beneficial to improving product quality and production efficiency.

As a preferred solution of the invention, in the step S2, in the process of die-cutting, a cutter cuts from a side of the flexible magnetic sheet away from the carrier sheet, penetrates the flexible magnetic sheet, and does not exceed a surface of the adhesive layer away from the flexible magnetic sheet; when a single small magnetic sheet is separated from the cut flexible magnetic sheet, the small magnetic sheet is separated from the adhesive layer of the carrier sheet. After magnetization is completed, an upward surface of the small magnetic sheet is a strong magnetic surface, and the other surface is a weak magnetic surface. When the decoration body is subsequently bonded to the flexible magnetic strip carrier, the small magnetic sheet is removed from the entire structure, which makes it easy to distinguish between the strong magnetic surface and the weak magnetic surface, facilitating the implementation of subsequent processes.

As a preferred solution of the invention, in the step S2, in the process of cutting, the cutter cuts from the side of the flexible magnetic sheet away from the carrier sheet, penetrates the flexible magnetic sheet, passes through the adhesive layer, and does not exceed a side of the base layer away from the adhesive layer; when a single small magnetic sheet is separated from the cut flexible magnetic sheet, the adhesive layer on the carrier sheet that is bonded to the small magnetic sheet is separated from the base layer. When a medical-grade glue is used as the adhesive layer, the adhesive layer may be used as glue for bonding the decoration body, and the decoration body may be directly connected to the adhesive layer in the small magnetic sheet.

As a preferred solution of the invention, one side of the flexible magnetic strip carrier away from the carrier sheet is a strong magnetic surface,

and the opposite surface is a weak magnetic surface.

As a preferred solution of the invention, the plurality of the small magnetic sheets are arranged in parallel. When the plurality of small magnetic sheets are arranged in parallel, the intervals between the small magnetic sheets may be reduced, thereby improving the utilization rate of the flexible magnetic sheets

As a preferred solution of the invention, the flexible magnetic sheet is formed by unrolling a coil, and a plurality of small magnetic sheets

are arranged in parallel along a width direction of the flexible magnetic sheet.

The flexible magnetic sheet has a length direction; the plurality of small magnetic sheets are arranged along the width direction of the flexible magnetic sheet, and each of the small magnetic sheets extends from

one end to the other end along the length direction of the flexible magnetic sheet.

The important indicator of the flexible magnetic strip carrier is that they are not prone to cracks and breaks during processing. When die-cutting is used, the plurality of small magnetic sheets

are cut and formed at the same time. The flexible magnetic sheets are usually produced and transported in the form of coils, and the flexible magnetic sheets have a certain degree of curvature after being rolled. The flexible magnetic strip carrier has a small width, so the flexible magnetic strip carrier breaks in the length direction and breaks into two shorter strips. When the width direction of the small magnetic sheet is arranged along the width direction of the flexible magnetic sheet, the small magnetic sheets are less likely to break in the length direction. This arrangement is beneficial to improving product quality and product qualification rate.

As a preferred solution of the invention, the carrier sheet is a self-adhesive sheet.

As a preferred solution of the invention, in the step S1, the flexible magnetic sheet is prepared by:
mixing a NdFeB powder, a bonding powder and an additive in proportion, heating and then using a calendering process;
the NdFeB powder is a flaky NdFeB powder, the bonding powder is silicone rubber, the additive is a titanate coupling agent. Since the proportion of the NdFeB powder in the mixture is relatively large, a usual ratio is: NdFeB powder:bonding powder:additive=85-90:7-9:1-8. When the flaky NdFeB powder, especially a long strip-shaped flaky NdFeB powder, is used, the magnetic powder is stacked to form a laminated structure, which is not easy to break.

As a preferred solution of the invention, a particle size of the NdFeB powder is 150-300 mesh, preferably 200-300 mesh, and more preferably 250-300 mesh. When the size of the flexible magnetic strip carrier is constant, another parameter of concern is the smoothness of the surface of the flexible magnetic strip carrier. Since the carrier is in direct contact with the human eye skin, this parameter directly affects the wearing comfort. When the magnetic powder within the above-mentioned particle size range is used, the appearance of the finished product is smoother and more comfortable to wear. The uniform distribution of the particle size also makes the magnetic powder filling more dense, and the density of the magnetic strip carrier is increased, which is beneficial to improving the magnetic properties. Moreover, when die-cutting, finer magnetic powder is used, so cracks are less likely to occur on the sides.

A flexible magnetic strip carrier prepared by the method for preparing a flexible magnetic strip carrier according to the above descriptions.

An eyelash decoration includes the flexible magnetic strip carrier as described above, and a decoration body. The decoration body includes a root portion and a hair portion; the root portion of the decoration body is bonded to the weak magnetic surface of the flexible magnetic strip; when the flexible magnetic strip is bonded with the adhesive layer of the carrier sheet, the root portion of the decoration body is directly bonded to the adhesive layer.

In summary, due to the above technical solutions, the invention achieves the following beneficial effects:

The method for preparing a flexible magnetic strip carrier according to the invention is to bond the flexible magnetic sheet to the carrier sheet to form a whole sheet structure, wherein only the flexible magnetic sheet layer is cut during cutting, so that it is easy to use a die-cutting tool to cut the whole sheet, and the small magnetic strips formed after cutting are bonded to the carrier sheet and will not fall off; during magnetization, the entire flexible magnetic sheet after cutting may be magnetized as a whole, and may adapt to a flat magnetizing mold; during magnetization, the small magnetic sheet will not slide, and the consistency of the magnetization effect of the small magnetic sheet may be guaranteed. The method is further beneficial to improving product quality and production efficiency.

The method for preparing a flexible magnetic strip carrier according to the invention takes into account the influence of the bending of the flexible magnetic strip carrier and arranges the small magnetic sheets in parallel along the width direction of the flexible magnetic strip, thereby reducing the risk of the small magnetic sheets breaking in the length direction and improving the product quality and product qualification rate.

The method for preparing a flexible magnetic strip carrier according to the invention uses the flaky NdFeB powder in the flexible magnetic sheet, wherein the particle size of the powder is 250-300 mesh, so that the magnetic powder may be evenly stacked and distributed in the magnetic sheet to form a stacked structure, and the edges are not prone to breakage during cutting. The uniform distribution of the particle size also makes the surface of the product smooth, and the dense filling increases the density of the carrier, ensuring the magnetic properties of the product.

The eyelash decoration according to the invention includes the above flexible magnetic strip carrier, so that the eyelash decoration is more comfortable to wear on the one hand; and since the flexible magnetic strip carrier itself is bonded to the carrier sheet, the front surface is the strong magnetic surface and the back surface is the weak magnetic surface, the strong magnetic surface and the weak magnetic surface are easy to distinguish, wherein when the decoration body is bonded to the flexible magnetic strip carrier, it is very easy to distinguish the two surfaces, which is beneficial to improve the quality and production efficiency of the eyelash decoration.

### BRIEF DESCRIPTION OF DRAWINGS

FIG. 1 is a schematic diagram of the structure of an eyelash decoration in the prior art when in use.

FIG. 2 is a schematic diagram of the structure of a lower eyelash decoration in the prior art.

FIG. 3 is a schematic diagram of the structure of a lower eyelash decoration in the prior art.

FIG. 4 is a schematic cross-sectional view of a flexible magnetic sheet of Embodiment 1 after being loaded onto a carrier sheet.

FIG. 5 is a schematic diagram of the arrangement of the cut small magnetic sheets of Embodiment 1 in a segment of the flexible magnetic sheet.

FIG. 6 is a schematic diagram of the cross-sectional structure of FIG. 5 taken along line A-A.

FIG. 7 is a schematic diagram of the cut flexible magnetic sheet of Embodiment 1 during magnetization.

FIG. 8 is a schematic diagram of the structure of the flexible magnetic sheet of Embodiment 1 after magnetization is completed.

FIG. 9 is a schematic diagram of the structure of bonding a decoration body to a flexible magnetic strip carrier in Embodiment 1.

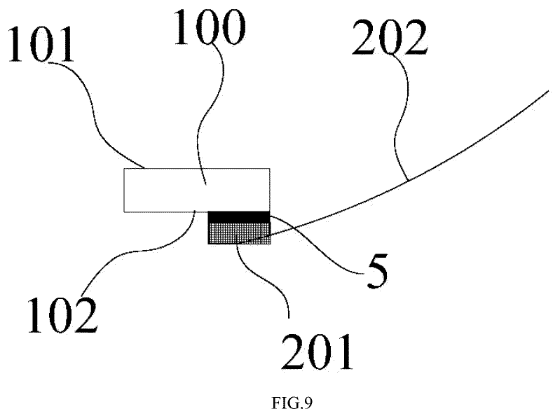

FIG. 10 is a schematic cross-sectional structure diagram of a segment of the cut flexible magnetic sheet corresponding to FIG. 6 in Embodiment 2.

FIG. 11 is a schematic diagram of the structure of bonding a decoration body to a flexible magnetic strip carrier in Embodiment 2.

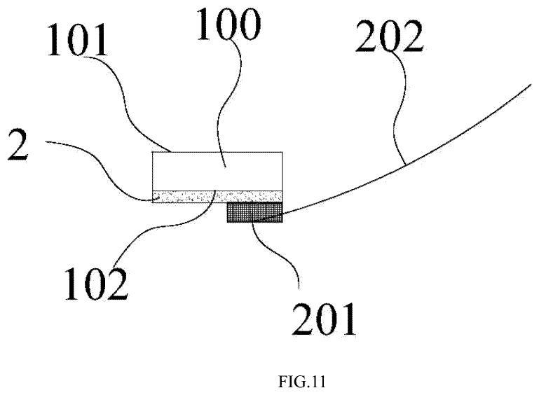

FIG. 12 is a schematic diagram of the arrangement of the cut small magnetic sheets of Embodiment 3 in a segment of the flexible magnetic sheet.

### REFERENCE NUMERALS IN FIGURES

1—flexible magnetic sheet; 2—adhesive layer; 3—base sheet; 4—magnetizing mold; 41—upper magnetizing mold; 42—lower magnetizing mold; 5—bonding glue;
100—lower flexible magnetic strip carrier; 101—strong magnetic surface; 102—weak magnetic surface; 200—lower decoration body; 201—root portion; 202—hair portion; 300—upper flexible magnetic strip carrier; 400—upper decoration body; 500—real eyelash.

### DETAILED DESCRIPTION OF THE EMBODIMENTS

The invention will be elaborated hereafter in connection with the drawings.

In order that the objectives, technical schemes and advantages of the present invention will become more apparent, the present invention will be described in more detail with reference to the drawings and examples above. It should be understood that the specific embodiments described herein are only for illustrating but not for limiting the present invention.

### Embodiment 1

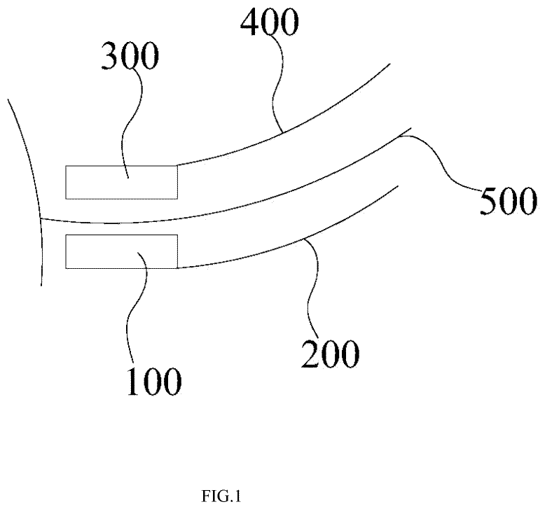

The eyelash decoration in the prior art includes an upper eyelash decoration and a lower eyelash decoration, wherein the upper eyelash decoration is used for the upper eyelash, and the lower eyelash decoration is used for the lower eyelash. Taking the upper eyelash decoration as an example, as shown in FIG. 1, the upper eyelash decoration includes two parts, i.e., a first eyelash decoration and a second eyelash decoration, wherein the first eyelash decoration includes a lower flexible magnetic strip carrier 100 and a lower decoration body 200 bonded to the lower flexible magnetic strip carrier 100; the second eyelash decoration includes an upper flexible magnetic strip carrier 300 and an upper decoration body 400 bonded to the upper flexible magnetic strip carrier 300; the lower flexible magnetic strip carrier 100 and the upper flexible magnetic strip carrier 300 are clamped on a real eyelash 500 by magnetic attraction.

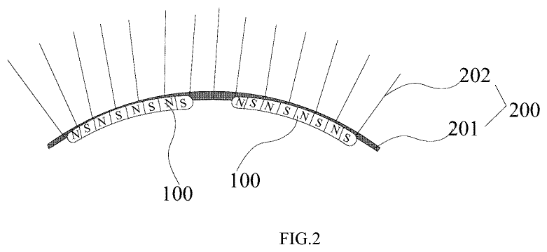

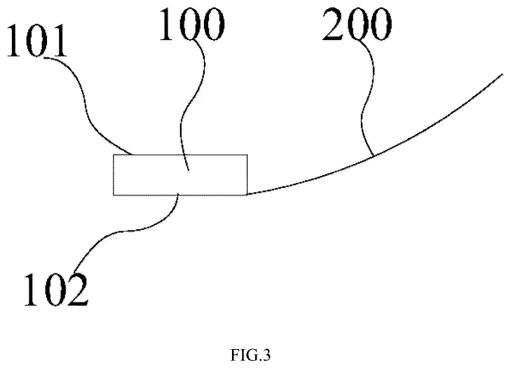

Taking the flexible magnetic strip carrier as an example, as shown in FIG. 2, the first eyelash decoration includes two flexible magnetic strip carriers 100. A root portion 201 of the lower decoration body 200 is bonded to the flexible magnetic strip carrier 100, and a hair portion 202 extends outward. Usually, upper and lower surfaces of the flexible magnetic strip carrier are respectively a strong magnetic surface and a weak magnetic surface. As shown in FIG. 3, the lower decoration body 200 is bonded to a lower side of the lower flexible magnetic strip carrier 100, wherein the upper side is a strong magnetic surface 101 and the lower side is a weak magnetic surface 102; similarly, the upper decoration body 400 is bonded to the upper side of the upper flexible magnetic strip carrier 300. Strong magnetic attraction is achieved through the strong magnetic surface of the lower flexible magnetic strip carrier 100 and the strong magnetic surface of the upper flexible magnetic strip carrier 300, so that the real eyelash 500 may be decorated.

In order to improve the production quality and production efficiency of the eyelash decoration of the above structure, the following production method is adopted. First, the flexible magnetic strip carrier is prepared, which includes the following steps:
S1, a carrier sheet and a flexible magnetic sheet are provided, wherein the carrier sheet includes a base layer and an adhesive layer which are stacked and the flexible magnetic sheet is bonded to the adhesive layer;
the plurality of the small magnetic sheets are arranged in parallel. When the plurality of small magnetic sheets are arranged in parallel, the intervals between the small magnetic sheets may be reduced, thereby improving the utilization rate of the flexible magnetic sheets

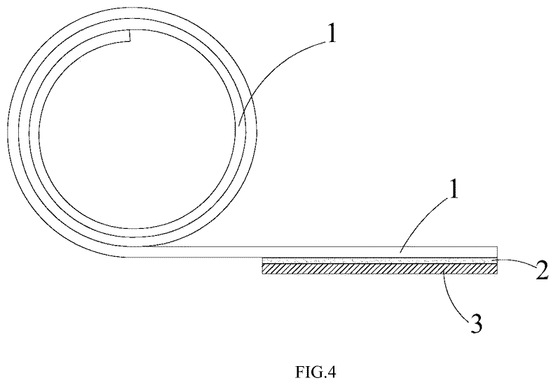

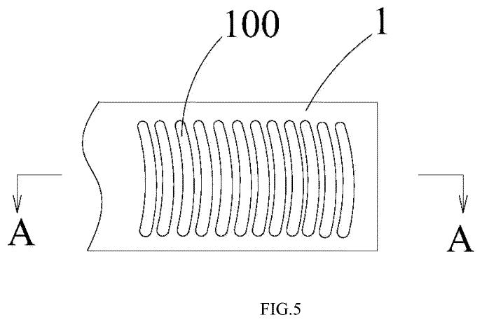

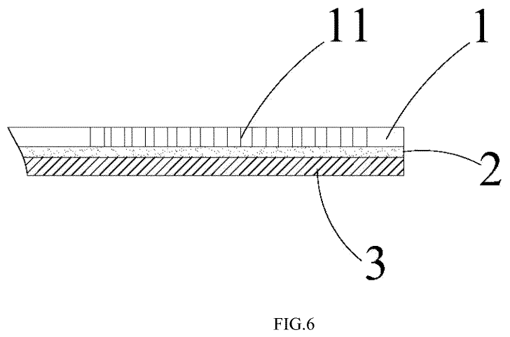

As shown in FIG. 4, the flexible magnetic sheet 1 is rolled up, and a portion of the flexible magnetic sheet 1 is unrolled and connected to the carrier sheet, wherein the carrier sheet includes a base layer 3 and an adhesive layer 2; the flexible magnetic sheet 1 is directly bonded to the adhesive layer 2 to achieve connection between the flexible magnetic sheet and the carrier sheet. As shown in FIG. 5 (the rolled flexible magnetic sheet is not shown), the plurality of small magnetic sheets are arranged in parallel. In FIG. 5, a left-right direction is a length direction, and an up-down direction is a width direction. Upper and lower sides are respectively a first side and a second side. An up-down direction of the small magnetic sheet is the length direction, and a left-right direction thereof is the width direction. In the embodiment, the width direction of the small magnetic sheet is substantially consistent with the length direction of the flexible magnetic sheet. Specifications of the cut small magnetic sheets are 10 mm in length, 1 mm in width and 0.15 mm in thickness.
S2, the flexible magnetic sheet is cut to obtain a cut flexible magnetic sheet, wherein the cut flexible magnetic sheet includes a plurality of small magnetic sheets, and the small magnetic sheets are all bonded to the adhesive layer 2; in the process of cutting, a cutter cuts from a side of the flexible magnetic sheet away from the carrier sheet, penetrates the flexible magnetic sheet, and does not exceed a surface of the base layer 3 away from the adhesive layer; high-precision CNC die-cutting machines may be used for cutting. As shown in FIG. 6, the cutter cuts from top to bottom, cutting through the flexible magnetic sheet 1, but the cutter does not enter the adhesive layer; in other embodiments, the cutter may also cut into a portion of the adhesive layer. In the process of die-cutting, a cutter cuts from a side of the flexible magnetic sheet away from the carrier sheet, penetrates the flexible magnetic sheet, and does not exceed a surface of the adhesive layer away from the flexible magnetic sheet; when a single small magnetic sheet is separated from the cut flexible magnetic sheet, the small magnetic sheet is separated from the adhesive layer of the carrier sheet. After magnetization is completed, an upward surface of the small magnetic sheet is a strong magnetic surface, and the other surface is a weak magnetic surface. When the decoration body is subsequently bonded to the flexible magnetic strip carrier, the small magnetic sheet is removed from the entire structure, which makes it easy to distinguish between the strong magnetic surface and the weak magnetic surface, facilitating the implementation of subsequent processes.
S3, a side of the cut flexible magnetic sheet away from the base layer is magnetized, wherein the small magnetic sheet after magnetization is the flexible magnetic strip carrier.

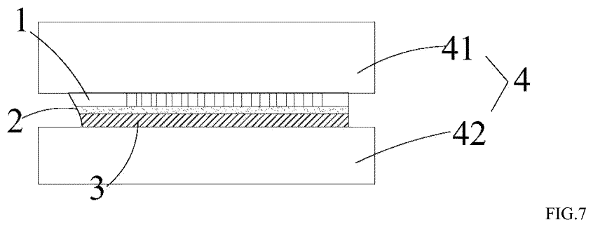

During magnetization, as shown in FIG. 7, the entire flexible magnetic sheet after cutting may be magnetized as a whole, and may adapt to a flat magnetizing mold 4. A lower surface of the upper magnetizing mold 41 and an upper surface of the lower magnetizing mold 42 of the magnetizing mold 4 are both flat, which can better clamp the flexible magnetic sheet after die-cutting. The small magnetic sheet will not slide during magnetization, and the consistency of the magnetization effect of the small magnetic sheet may be ensured. The method is further beneficial to improving product quality and production efficiency.

The carrier sheet is a self-adhesive sheet. Fabrics of the self-adhesive sheet are used as the base layer 3, and adhesives of the self-adhesive sheet is used as the adhesive layer 2.

The flexible magnetic sheet is prepared by mixing an NdFeB powder, a bonding powder and an additive in a ratio of 90:7:3, heating and then forming by a calendering process; the NdFeB powder is a flaky NdFeB powder with a particle size of 250-300 meshes; the bonding powder is silicone rubber; and the additive is a titanate coupling agent.

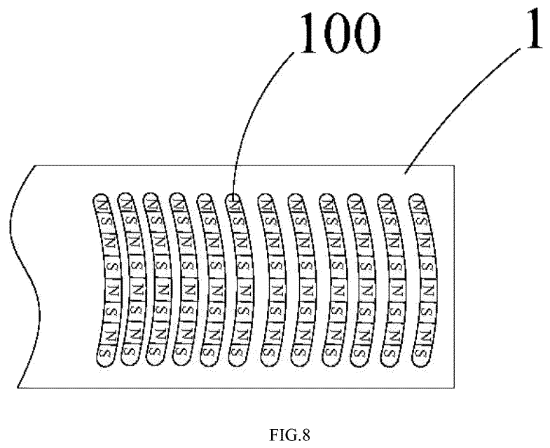

The arrangement for the magnetic pole of each small magnetic strip after magnetization is shown in FIG. 8. A side of each small magnetic strip away from the carrier sheet is the strong magnetic surface, and the other opposite side thereof is the weak magnetic surface. When in use, just the small magnetic strip is removed from the self-adhesive sheet.

### Embodiment 2

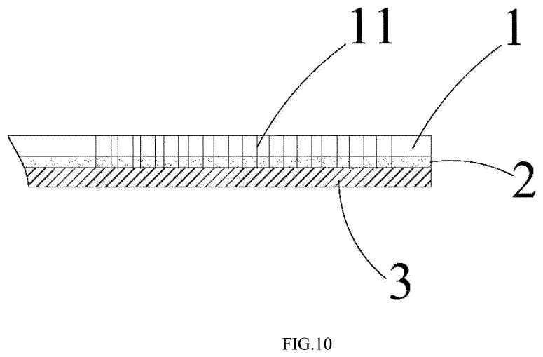

The embodiment differs from Embodiment 1 in that: in the step S2, in the process of cutting, as shown in FIG. 10, the cutter cuts from the side of the flexible magnetic sheet 1 away from the carrier sheet, penetrates the flexible magnetic sheet 1, passes through the adhesive layer 2, and does not exceed a side of the base layer 3 away from the adhesive layer; when a single small magnetic sheet is separated from the cut flexible magnetic sheet 1, the adhesive layer 2 on the carrier sheet that is bonded to the small magnetic sheet is separated from the base layer 3. When a medical-grade glue is used as the adhesive layer, the adhesive layer may be used as glue for bonding the decoration body, and the decoration body may be directly connected to the adhesive layer 2 in the small magnetic sheet.

### Embodiment 3

The important indicator of the flexible magnetic strip carrier includes being not prone to cracks and breaks during processing. Referring back to FIG. 4, when die-cutting is used, the plurality of small magnetic sheets are cut and formed at the same time. The flexible magnetic sheets are usually in the form of coils, and the flexible magnetic sheets have a certain degree of curvature after being rolled. The flexible magnetic strip carrier has a small width, so the flexible magnetic strip carrier easily breaks in the length direction of the small magnetic strip and breaks into two shorter strips.

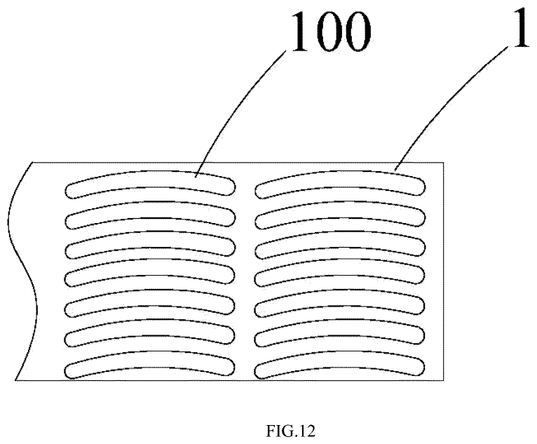

Usually the flexible cut sheets are coils, i.e., the flexible magnetic sheets are formed by unfolding the coils. The coils have different toughness in the length and width directions. Cutting the small magnetic sheets in different directions will result in different small magnetic sheets. The embodiment prepares according to Embodiment 1, but differs from Embodiment 1 in that: in the step S2, when die-cutting is performed, the mold is rotated 90 degrees, and the small magnetic sheets are arranged in parallel along the width direction of the flexible magnetic sheet, as shown in FIG. 12.

100 small magnetic sheets that have been die-cut but not magnetized in Embodiment 1 and 100 small magnetic sheets that have been die-cut but not magnetized in Embodiment 2 are taken for analysis of the product quality. The product quality is judged by whether there are obvious fracture lines on the cut edges of the small magnetic sheets.

The test results are shown as below.

| | | Total | Number | |
|---|---|---|---|---|
| | | number | of small | |
| | | of small | sheets | Qualifi- |
| | Cutting direction of | sheets | with cracks | cation |
| No. | small magnetic sheet | (piece) | (piece) | rate (%) |
| Embodi- | Arranged in parallel | 100 | 12 | 88% |
| ment 1 | along length direction of | | | |
| | flexible magnetic sheet | | | |
| Test | Arranged in parallel | 100 | 0 | 100% |
| Example 2 | along width direction of | | | |
| | flexible magnetic sheet | | | |

As shown in the test results in the table above, the product qualification rate of the method of parallel arrangement along the width direction of the flexible magnetic sheet (as shown in FIG. 12) is significantly higher than that of the method of parallel arrangement along the length direction of the flexible magnetic sheet (as shown in FIG. 5). When the small magnetic sheets are arranged in parallel along the width direction of the flexible magnetic sheet, the fracture lines are reduced. This arrangement method is beneficial to improving product quality and product qualification rate.

### Embodiment 4

A flexible magnetic strip carrier is prepared by using the method for preparing a flexible magnetic strip carrier according to Embodiment 1, 2 or 3.

### Embodiment 5

An eyelash decoration includes the flexible magnetic strip carrier according to Embodiment 4, and a decoration body. The decoration body includes a root portion and a hair portion; the root portion of the decoration body is bonded to the weak magnetic surface of the flexible magnetic strip; when the flexible magnetic strip is bonded with the adhesive layer of the carrier sheet, the root portion of the decoration body is directly bonded to the adhesive layer.

### Test Example 1

Since the proportion of the NdFeB powder in the mixture is relatively large, a usual ratio is: NdFeB powder:bonding powder:additive=85-90:7-9:1-8. When the flaky NdFeB powder, especially a long strip-shaped flaky NdFeB powder, is used, the magnetic powder is stacked to form a laminated structure, which is not easy to break. However, the particle size of the NdFeB powder also has a significant impact on the quality issues such as the appearance and breakage of the magnetic sheet.

During die-cutting, the flexible magnetic sheets are arranged in parallel along the width direction, and the flaky NdFeB powders with different distributions of particle size are used. The distribution of particle size is determined by sieving. The powders are sieved using 100-150 mesh, 200 mesh, 250 mesh and 300 mesh sieves. The powders are sieved to obtain powders in four particle size ranges: 100-150 mesh, 150-200 mesh, 200-250 mesh, and 250-300 mesh. The powders in the four ranges are subjected to a calendering process to produce flexible magnetic sheets in a ratio of solid NdFeB powder:bonding powder:additive=90:7:3. The method of Embodiment 1 is then used to prepare 120 small magnetic sheets of the same specification. The product quality is analyzed. The product quality is judged by whether there are obvious fracture lines on the cut edges of the small magnetic sheets. The test results are shown as below.

| | Particle size | Total number | Number of small | |
|---|---|---|---|---|
| | of magnetic | of small | sheets with | Qualification |
| No. | powder (mesh) | magnetic | cracks (piece) | rate (%) |
| 1-1 | 100-150 | 100 | 32 | 68% |
| 1-2 | 150-200 | 100 | 25 | 75% |
| 1-3 | 200-250 | 100 | 18 | 82% |
| 1-4 | 250-300 | 100 | 2 | 98% |

When the magnetic powder with larger particle size is used, after cutting, the number of small magnetic sheets with cracks on the edges is significantly higher, which affects the product qualification rate. It has been observed that as the particle size of the magnetic powder decreases, the glossiness of the surface of the small magnetic sheets increases. The product qualification rate of the flexible magnetic sheet made by using the magnetic powder with a particle size range of 150-300 mesh is significantly increased. When the process of Embodiment 1 is adopted, the product quality may be guaranteed.

The descriptions above are only preferred embodiments of the invention, but are not intended to limit the present invention. Any modifications, equivalent substitutions, improvement and the like made within the spirit and principles of the invention are all intended to be concluded in the protection scope of the invention.

What is claimed is:

1. A method for preparing a flexible magnetic strip carrier, comprising steps of:
S1, providing a carrier sheet and a flexible magnetic sheet, wherein the carrier sheet comprises a base layer and an adhesive layer which are stacked and the flexible magnetic sheet is bonded to the adhesive layer, and the flexible magnetic sheet is a flexible magnetic sheet formed by unrolling a coil; the flexible magnetic sheet is prepared by mixing a NdFeB powder, a bonding powder and an additive in proportion, heating and then using a calendering process; the NdFeB powder is a flaky NdFeB powder, the bonding powder is silicone rubber, the additive is a titanate coupling agent, and a particle size of the NdFeB powder is 200-300 mesh;
S2, cutting the flexible magnetic sheet to obtain a cut flexible magnetic sheet, wherein the cut flexible magnetic sheet comprises a plurality of small magnetic sheets, the small magnetic sheets are all bonded to the adhesive layer, and the small magnetic sheets are arranged in parallel along a width direction of the flexible magnetic sheet; specifications of the cut small magnetic sheet are 10 mm in length, 1 mm in width and 0.15 mm in thickness;
if a cutter cuts from a side of the flexible magnetic sheet away from the carrier sheet, penetrates the flexible magnetic sheet, and does not exceed a surface of the adhesive layer away from the flexible magnetic sheet in the process of cutting, the small magnetic sheet is separated from the adhesive layer of the carrier sheet when a single small magnetic sheet is separated from the cut flexible magnetic sheet; if the cutter cuts from the side of the flexible magnetic sheet away from the carrier sheet, penetrates the flexible magnetic sheet, passes through the adhesive layer, and does not exceed a side of the base layer away from the adhesive layer, the adhesive layer on the carrier sheet that is bonded to the small magnetic sheet is separated from the base layer when a single small magnetic sheet is separated from the cut flexible magnetic piece;
S3, magnetizing a side of the cut flexible magnetic sheet away from the base layer, wherein the small magnetic sheet after magnetization is the flexible magnetic strip carrier.

2. The method for preparing a flexible magnetic strip carrier according to claim 1, wherein the carrier sheet is a self-adhesive sheet.

3. A flexible magnetic strip carrier prepared by the method for preparing a flexible magnetic strip carrier according to claim 1.

4. An eyelash decoration, comprising the flexible magnetic strip carrier according to claim 3, and a decoration body,
wherein the decoration body comprises a root portion and a hair portion, and the root portion of the decoration body is bonded to a weak magnetic surface of the flexible magnetic strip;
when the flexible magnetic strip is bonded with the adhesive layer of the carrier sheet, the root portion of the decoration body is directly bonded with the adhesive layer.
